(19) United States
(12) Patent Application Publication
(10) Pub. No.: US 2002/0172338 A1
(43) Pub. Date: Nov. 21, 2002

(54) Multimedia caller identification

(76) Inventors: Anne Yin-Fee Lee, Naperville, IL (US); Patricia Ann Riley, St. Charles, IL (US)

Correspondence Address: Reginald J. Hill, R.J. Hill & Associates, Ltd., Suite 1402, 19 South LaSalle Street, Chicago, IL, 60603, US

(21) Appl. No.: 09/862,139

(22) Filed: May 21, 2001

(51) Int. Cl. H04M 1/64; H04M 1/56; H04M 3/42

(52) U.S. Cl. 379/142.01; 379/88.21; 455/415; 379/93.23

(57) ABSTRACT

In a multimedia communications system (100) that provides for two-way voice calls, multimedia caller identification data is provided to destinations for calls. A message is generated to set up the interactive communications session between the user terminal (102) and destination (202). The user terminal is a wireless communication device with an over-the-air interface for communicating with the network or the user terminal is a wired device (144, 154) that is coupled to the system. Caller identification data is added to the message (204). The caller identification data includes at least one of audio data and video data. For example, the caller identification data may include a video clip, logo, animation or tune. The caller identification data is alternatively added by the user terminal or a processor in the multimedia communications network. The caller identification data and the message are transmitted to the destination (206). The path for transmission preferably includes a packet-based network. At the destination, the caller identification data is displayed, including a visual display of video data and an audible display of audio data (208). If the call is answered, resources are allocated for bearer paths between the user terminal and the destination.

### FIELD OF THE INVENTION

The invention generally relates to telecommunications networks, and in particular, to the provision of multimedia caller identification in a multimedia telecommunications network.

### BACKGROUND OF THE INVENTION

Wireless communication systems are well known. Wireless communication systems allow mobile radiotelephones to communicate with each other and other networks, such as the Internet and the public telephone network. First and second generation wireless telephone systems are generally constrained in the amount of bandwidth available for communication. This limits capacity and also the types of services that are provided. Third generation wireless systems hold the promise of greater bandwidth, thereby increasing capacity and allowing for enhanced services, such as multimedia services. Proposed third generation wireless communications devices include, in addition to a voice communication interface, capability for communication of data and display of data, including video.

Presently, when voice calls in a telecommunications network are placed, a caller identification (ID), consisting of a name and phone number, is provided at the destination. This information is limited and typically is associated with a line or handset, rather being associated with the actual caller.

Therefore, a need exist for improved and enhanced caller identification that exploits the recent advancements of telecommunications systems.

### SUMMARY OF THE INVENTION

A method is provided for sending multimedia caller identification data prior to an interactive communications session on a multimedia communications network. First a message is generated to set up the interactive communications session between a user terminal and destination. The user terminal is a wireless communication device with an over-the-air interface for communicating with the network or the user terminal is a wired device that is coupled to the system. Caller identification data is added to the message that sets up the interactive communications session. The caller identification data includes at least one of audio data and video data. For example, the caller identification data may include a video clip, logo, animation or tune. The caller identification data is alternatively added by the user terminal or a processor in the multimedia communications network. The caller identification data and the message are transmitted to the destination. The path for transmission preferably includes a packet-based network. At the destination, the caller identification data is displayed, including a visual display of video data and an audible display of audio data. A telecommunications network is provided with processors that implement the steps of the above-described method.

### BRIEF DESCRIPTION OF THE DRAWINGS

FIG. 1 is a block diagram of a wireless voice-over-IP network that provides multimedia caller identification in accordance with the present invention.

FIG. 2 is a flow chart illustrating a method for providing multimedia caller identification in accordance with the present invention.

### DESCRIPTION OF THE PREFERRED EMBODIMENTS

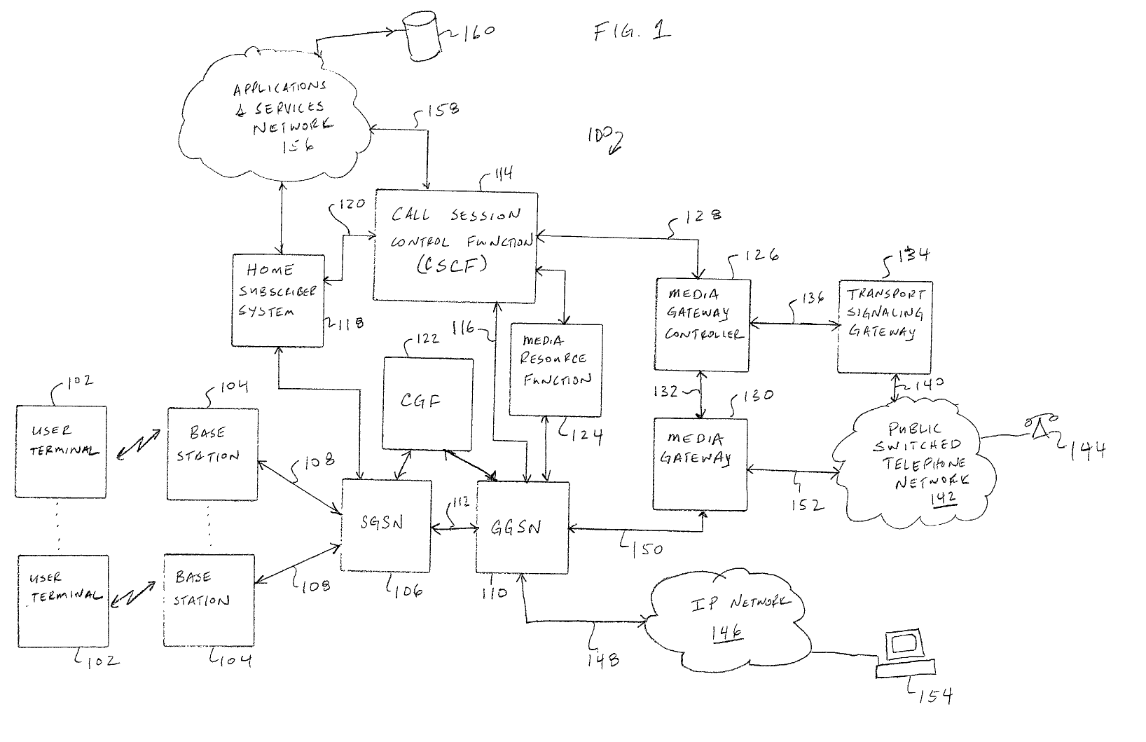

FIG. 1 is a block diagram of a preferred embodiment of a multimedia communications system 100 in accordance with the present invention. Users interact with multimedia communications system 100 via user equipment or user terminals 102. Multimedia communications system 100 includes a third generation wireless system, as defined and proposed by the 3^{rd} Generation Partnership Program, also known as 3GPP (see 3gpp.org). User terminal 102 is typically a mobile device that includes a user interface and an interface for coupling to communications system 100. The user interface of user terminal 102 is typically referred to as terminal equipment and generally includes an audio interface, such as a microphone and speakers, a visual interface, such as a display, and a user input interface, such as a keyboard or touch pad. The interface for coupling to communications system 100 is typically referred to as a mobile terminal and generally includes an over-the-air interface for transmitting and receiving data.

The over-the-air interface of user terminal 102 is used to communicate with base stations 104. In the preferred embodiment, base stations 104 include an over-the-air interface that is complementary to the over-the-air interface of user terminal 102. Most preferably, user terminal 102 and base stations 104 communicate over the air using a packet-based protocol.

Multimedia communications system 100 provides users with a variety of options for communication. Users are able to transmit and receive multimedia communications, including audio, voice, video, and all types of data. Multimedia communications system 100 provides access to data networks, such as the Internet, and public telephone networks, including wireless networks.

In the preferred embodiment, the multimedia communications that are directed to and received from users via base stations 104 are coordinated and transferred using a serving GPRS (GSM Packet Radio System) support node (SGSN) 106, a gateway GPRS support node (GGSN) 110, a call session control function (CSCF) 114 and a home subscriber system 118. SGSN 106 coordinates multimedia transmissions to and from base stations 104. SGSN 106 is coupled to GGSN 110 via a data link 112. GGSN 110 interfaces the multimedia communications to and from SGSN 106 to other networks. Call session control function 114 is coupled to GGSN 110 via a data link 116. Call session control function 114 coordinates and executes a signaling protocol used to establish, maintain and control calls or sessions for communications involving user terminals 102. A home subscriber system 118 is coupled to call session control function 114 via a data link 120. Home subscriber system 118 includes subscriber profile information, including information traditionally associated with a home location register for a mobile subscriber.

To facilitate ancillary and support functions within multimedia communications system 100, a charging gateway function (CFG) 122 and a media resource function 124 are provided. Charging gateway function 122 is coupled to SGSN 106 and GGSN 110 to account for packets passing through these elements for accounting, billing and other purposes. Media resource function 124 is coupled to call session control function 114 and to GGSN 110. Media resource function 124 provides resources for conference bridging, tones, announcements and other service functions for communications through GGSN 110.

GGSN 110 couples user terminals 102 to other networks. In particular, GGSN 110 is coupled to an Internet protocol (IP) network 146 via a data link 148. Data link 148 preferably implements a packet-based protocol for transfers to a data network. Data link 148 and IP network 146 provide access to any elements connected to IP network 146, such as, for example, a computer 154. GGSN 110 is also coupled to a media gateway 130 via a data link 150. Media gateway 130 is in turn coupled to a public switched telephone network 142 via a communications link 152. Media gateway 130 converts data received from GGSN 110 to a data protocol acceptable to the public switched telephone network 142. Conversely, media gateway 130 converts data received from public switched telephone network 142 to a protocol acceptable to GGSN 110. Media gateway 130, data link 150, and communications link 152 provide an interface for user terminals 102 to the public switched telephone network 142. By virtue of this connection, user terminals 102 are coupled to elements attached to the public switched telephone network, such as telephone 144.

The signaling and control necessary to interface GGSN 110 with public switched telephone network 142 is controlled and provided by call session control function 110, a media gateway controller 126 and a transport signaling gateway 134. Media gateway controller 126 is coupled to call session control function 114 via a data link 128. Media gateway controller 126 is coupled to control media gateway 130 via data ink 132. Call session control function 114 determines based on a signaling protocol any necessary media gateway resources needed for a particular communication or session. These needs are transmitted to media gateway controller 126, which in turns configures and establishes the necessary resources in media gateway 130 and also provides the necessary signaling to transport signaling gateway 134. The resources in media gateway 130 are configured to transfer the actual (bearer) data between the GGSN 110 and the public switched telephone network 142. Transport signaling gateway 134 converts the signaling protocol from the media gateway controller 136 to a signaling protocol necessary for public switched telephone network 142.

Applications and services are preferably coupled to multimedia communication system 100 for use in interaction with user terminals 102. In particular, call session control function 114 is coupled to an applications and services network 156 via a data link 158. Also, home subscriber system 118 is preferably coupled to application and services network 156. A myriad of services and applications may reside in or be coupled to application services network 156, including database services from a database 160.

In the preferred embodiment, SGSN 106, GGSN 110, CGF 122, media resource function 124, CSCF 114, media gateway controller 126, media gateway 130, and home subscriber system 118 are processor-based apparatus with data link interfaces for coupling together as described above and shown in FIG. 1. These apparatus include one or more processors that execute programs to implement the functionality described herein and generally associated with third generation wireless systems.

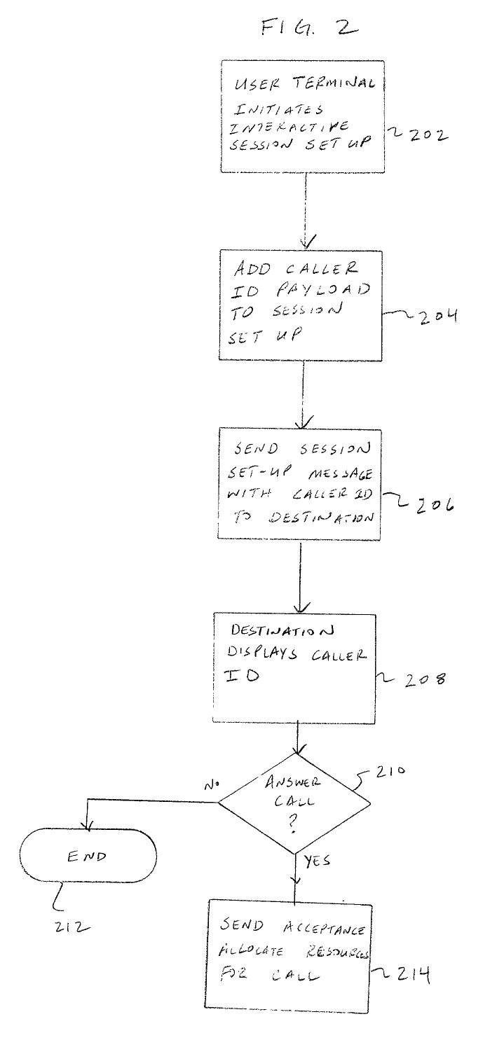

FIG. 2 is a flow chart illustrating a preferred method for delivering multimedia caller ID in accordance with the present invention. FIG. 2 is described below with reference to the preferred embodiment shown in FIG. 1. In the preferred method shown in FIG. 2, user terminal 102 initiates a call over multimedia communications system 100.

To begin the call, user terminal 102 initiates a call session set up (202). In the preferred embodiment, this entails user terminal 102 sending a SIP (Session Initiation Protocol) INVITE message (as defined by Internet Engineering Task Force—IETF-RFC 2543) to establish a call. Although a SIP INVITE message is preferred for the multimedia communications system 100 shown in FIG. 1, any other call setup protocol that is suitable for establishing voice calls over an IP network may be used. In accordance with the present invention, caller identification data is added to the call session setup message (204). In the preferred embodiment, a caller ID payload is added to the SIP INVITE message that user terminal 102 uses to establish the call. The caller ID payload preferably includes multimedia data, such as text, audio and video, to identify the caller. For example, the caller ID payload may consist of a digital representation of a logo, a short video clip, a short tune, a cartoon or other identifier.

In one preferred embodiment of the invention, the caller ID payload is stored on, or derived from, user terminal 102 and is included in the call session setup message by user terminal 102. In this case, the caller ID payload may be derived directly from an input device on user terminal 102, such as a camera or microphone. Alternatively, the caller ID payload may be stored in a memory on user terminal 102. In an alternate preferred embodiment of the invention, the caller ID payload associated with a particular user terminal 102 is stored in multimedia communications system 100 and is added to the call session setup message by an element of multimedia communications system 100. For example, home subscriber system 118 or an application server in application and services network 156 may store caller ID payloads associated with user terminals 102 that are associated with multimedia communications system 100. In this case, a SIP INVITE message used to setup a call session from user terminal 102 is passed to call session control function 114. Call session control function 114 obtains the caller ID payload from home subscriber system 118 or an application server in application and services network 156 that is associated with the particular user terminal 102. The call session control function 114 appends the caller ID payload to the SIP INVITE message that is passed across multimedia communications system 100. Most preferably, the caller identification payload is selectable by a user of user terminal 102 at a time the call is placed. This advantageously permits caller identification data to be associated with a caller rather than a device.

The session setup message, including the caller ID payload, is sent to the destination for the call (206). The destination is any device that can be coupled to multimedia communications system 100 and is preferably another user terminal 102, or a multimedia enabled device, such as computer 154, that also serves as a user terminal. The destination receives the call setup message and displays the caller ID (208). The nature of the display varies according to the content of the caller ID payload. Also, the display varies depending upon the capabilities of the destination. For example, if the caller ID payload includes a video clip, the display includes showing the frames of the video clip. If the caller ID includes audio, then the destination displays the ID by playing the audio.

If the destination does not answer the call (210), then no further action is required (212). On the other hand, if the call is answered by the destination (210), then an appropriate acceptance message is preferably transmitted across multimedia communications system 100 and the appropriate resources are allocated for the requested call (214). In the preferred embodiment, the destination accepts the SIP INVITE and bearer resources are established for two-way communications between user terminal 102 and the destination. Most preferably, call session control function 114 coordinates the establishment of resources, including bearer resources to transmit the voice of the two-way communication between user terminal 102 and a destination.

Although FIG. 2 describes a call initiated by user terminal 102 that is directly coupled to multimedia communications system 100, multimedia caller ID is also preferably provided for calls placed by other communication devices that are capable of coupling to multimedia communications system 100. For example, multimedia caller ID is provided in accordance with the present invention for traditional telephone devices, such as telephone 144, that may be coupled to multimedia communications system 100 via the public switched telephone network 142. In this case, the call session setup message is handled by the media gateway controller 126, transport signaling gateway 134, and media gateway 130. The caller ID payload associated with telephone 144 is preferably added to the call session setup message via a network element coupled to multimedia communications system 100. For example, caller ID payloads may be stored in applications and services network 156, home subscriber system 118 or a server on IP network 146. The caller ID payload is added to the session setup message and transported to the destination as described above with respect to FIG. 2.

As disclosed herein, multimedia caller ID is provided for calls placed over a multimedia communications system. The multimedia caller ID permits users to provide enhanced unique information regarding a particular call.

Whereas the present invention has been described with respect to specific embodiments thereof, it will be understood that various changes and modifications will be suggested to one skilled in the art and it is intended that the invention encompass such changes and modifications as fall within the scope of the appended claim.

1. A method for providing multimedia caller identification for calls placed in a multimedia communications system, the method comprising the steps of:
generating a message to set up an interactive communication session between a user terminal and a destination;
adding caller identification data to the message, wherein the caller identification data includes at least one of audio data and video data;
sending the message to the destination; and
displaying the caller identification data at the destination.

2. The method of claim 1 wherein the user terminal generates the message and adds the caller identification data.

3. The method of claim 2 wherein the caller identification data is derived from a visual input device or audio input device on the user terminal.

4. The method of claim 1 wherein a processor in a multimedia communications network adds the caller identification data to the message.

5. The method of claim 4 wherein the caller identification data is stored in an element coupled to a multimedia communications network.

6. The method of claim 1 wherein the step of sending the message to the destination includes sending the message over a packet-based network.

7. The method of claim 1 further comprising the step of allocating bearer resources to transport voice data to and from the destination.

8. A telecommunications network that provides multimedia caller identification, the telecommunications network comprising:
a first processor that generates a message to set up an interactive communication session between a user terminal and a destination;
a second processor that adds caller identification data to the message, wherein the caller identification data includes at least one of audio data and video data;
a third processor that sends the message to the destination;
a fourth processor that displays the caller identification data at the destination.

9. The network of claim 8 wherein the first processor, second processor and third processor are a same processor.

10. The network of claim 9 wherein the same processor is on a user terminal.

11. The network of claim 8 wherein the caller identification data is derived from a visual input device or audio input device on the user terminal.

12. The network of claim 8 wherein the caller identification data is stored in an element coupled to a multimedia communications network.

13. The network of claim 8 wherein the message is sent to the destination over a packet-based network.

14. The network of claim 8 further comprising a fifth processor that allocates bearer resources to transport voice data to and from the destination.
